(19) United States
(12) Patent Application Publication
(10) Pub. No.: US 2018/0111097 A1
(43) Pub. Date: Apr. 26, 2018

(54) METHOD OF OPERATING FILTRATION APPARATUS AND FILTRATION APPARATUS

(71) Applicant: SUMITOMO ELECTRIC INDUSTRIES, LTD., Osaka-shi, Osaka (JP)

(72) Inventors: Hiromu TANAKA, Osaka (JP); Hiroko MIKI, Osaka (JP); Toru MORITA, Osaka (JP); Tomoyuki YONEDA, Osaka (JP)

(73) Assignee: SUMITOMO ELECTRIC INDUSTRIES, LTD., Osaka-shi, Osaka (JP)

(21) Appl. No.: 15/562,967

(22) PCT Filed: Apr. 25, 2016
(86) PCT No.: PCT/JP2016/062867

§ 371 Date: Sep. 29, 2017

(30) Foreign Application Priority Data
May 7, 2015 (JP) 2015-094790

(51) Int. Cl. B01D 65/02; C02F 1/44; B01D 69/08; B01D 63/02

(52) U.S. Cl. CPC B01D 65/02; C02F 1/444; B01D 2321/185; B01D 63/02; B01D 69/08

(57) ABSTRACT

A method of operating a filtration apparatus according to the present invention is a method of operating a filtration apparatus which includes one or more filtration modules provided with a plurality of hollow-fiber membranes arranged in parallel in one direction and a pair of holding members configured to fix both ends of the plurality of hollow-fiber membranes, and one or more cleaning modules configured to supply bubbles from below the filtration modules, the method including an operation step of carrying out a filtration treatment with the filtration modules, and a cleaning step of cleaning the filtration modules while stopping the filtration treatment with the filtration modules for 0.25 to 3 hours. The cleaning step is performed at intervals of 12 to 72 hours.

### TECHNICAL FIELD

The present invention relates to a method of operating a filtration apparatus and a filtration apparatus.

### BACKGROUND ART

Filtration apparatuses including filtration modules, in which a plurality of hollow-fiber membranes are bundled together, have been used as solid-liquid separation treatment apparatuses in sewage treatment and in processes for producing pharmaceuticals and the like.

Such filtration apparatuses are used while being immersed in a liquid to be treated. Permeation of the hollow-fiber membranes by impurities contained in the liquid to be treated is prevented at the surfaces of the hollow-fiber membranes, and permeation of the hollow-fiber membranes by liquid other than the impurities is allowed. Thereby, a filtration treatment is carried out.

However, in such filtration apparatuses, since permeation of the hollow-fiber membranes by impurities contained in the liquid to be treated is prevented at the surfaces of the hollow-fiber membranes, when the filtration treatment is carried out continuously, the impurities adhere to the surfaces of the hollow-fiber membranes, which causes membrane fouling. Accordingly, in such filtration apparatuses, membrane fouling is prevented by intermittently performing filtration treatment operations and cleaning the hollow-fiber membranes between the filtration treatment operations.

Furthermore, according to existing knowledge, as the filtration treatment operation time increases, the adhesion amount of impurities to surfaces of hollow-fiber membranes increases, and therefore, the hollow-fiber membranes are supposed to be cleaned frequently and periodically. Accordingly, in existing methods of operating filtration apparatuses, a process is generally employed in which filtration treatment operations, each lasting for about 7 minutes, are intermittently performed with an operation stop period of about one minute interposed therebetween, and surfaces of hollow-fiber membranes are abraded with bubbles during the operation stop period to remove impurities adhering to the surfaces of the hollow-fiber membranes (refer to Japanese Unexamined Patent Application Publication No. 2012-170895).

### CITATION LIST

### Patent Literature

PTL 1: Japanese Unexamined Patent Application Publication No. 2012-170895

### SUMMARY OF INVENTION

### Technical Problem

However, when such intermittent operations are performed continuously, impurities are gradually deposited on the surfaces of the hollow-fiber membranes, and the impurities may prevent permeation of the hollow-fiber membranes by a filtrated liquid and may block the spaces between a plurality of hollow-fiber membranes. This decreases the filtration treatment efficiency and increases the pressure required for the filtration treatment, resulting in an increase in operation costs, all of which are problems.

The present invention has been accomplished under these circumstances. It is an object of the invention to provide a method of operating a filtration apparatus in which it is possible to suppress an increase in operation costs while preventing membrane fouling and to provide a filtration apparatus.

### Solution to Problem

A method of operating a filtration apparatus according to an embodiment of the present invention, which has been developed to solve the problems described above, is a method of operating a filtration apparatus which includes one or more filtration modules provided with a plurality of hollow-fiber membranes arranged in parallel in one direction and a pair of holding members configured to fix both ends of the plurality of hollow-fiber membranes, and one or more cleaning modules configured to supply bubbles from below the filtration modules, the method including an operation step of carrying out a filtration treatment with the filtration modules, and a cleaning step of cleaning the filtration modules while stopping the filtration treatment with the filtration modules for 0.25 to 3 hours. The cleaning step is performed at intervals of 12 to 72 hours.

### Advantageous Effects of Invention

In the method of operating a filtration apparatus according to the present invention, it is possible to suppress an increase in operation costs while preventing membrane fouling.

### BRIEF DESCRIPTION OF DRAWING

FIG. 1 is a schematic diagram showing a filtration apparatus according to an embodiment of the present invention.

### REFERENCE SIGNS LIST

1 filtration module
2 cleaning module
3 cleaning chemical liquid supply mechanism
3a chemical liquid supply pump
3b chemical liquid supply pipe
4 control mechanism
4a control unit
11 hollow-fiber membrane
12 upper holding member
12a drain nozzle
13 lower holding member
14 water collecting pipe
15 suction pump
16 air supplier
17 air header
18 opening and closing valve
W storage tank

### DESCRIPTION OF EMBODIMENTS

### Description of Embodiments of the Present Invention

First, embodiments of the present invention will be described one by one.

A method of operating a filtration apparatus according to an embodiment of the present invention is a method of operating a filtration apparatus which includes one or more filtration modules provided with a plurality of hollow-fiber membranes arranged in parallel in one direction and a pair of holding members configured to fix both ends of the plurality of hollow-fiber membranes, and one or more cleaning modules configured to supply bubbles from below the filtration modules, the method including an operation step of carrying out a filtration treatment with the filtration modules, and a cleaning step of cleaning the filtration modules while stopping the filtration treatment with the filtration modules for 0.25 to 3 hours. The cleaning step is performed at intervals of 12 to 72 hours.

The method of operating a filtration apparatus includes an operation step of carrying out a filtration treatment with filtration modules, and a cleaning step of cleaning the filtration modules while stopping the filtration treatment for the period described above. The cleaning step is performed at the intervals described above. Thereby, it is possible to prevent impurities, which have been deposited on the surfaces of the hollow-fiber membranes, from blocking the spaces between the hollow-fiber membranes, compared with the existing case where, for example, a cleaning cycle is repeated, in which filtration treatment operations, each lasting for about 7 minutes, are intermittently performed with an operation stop period of about one minute interposed therebetween. Therefore, in the method of operating a filtration apparatus, it is possible to suppress an increase in operation costs by promoting a decrease in the chemical liquid cleaning frequency and a reduction in the amount of air during the operation while preventing membrane fouling.

The operation step and the cleaning step may be repeatedly performed. By repeatedly performing the operation step and the cleaning step, it is possible to promote the effect of preventing membrane fouling and the effect of suppressing operation costs for the filtration apparatus.

In the cleaning step, bubbles may be supplied by the cleaning modules. By supplying bubbles by the cleaning modules in the cleaning step, it is possible to appropriately remove impurities which have adhered to the surfaces of the hollow-fiber membranes and to promote the effect of preventing membrane fouling.

A filtration apparatus according to another embodiment of the present invention includes one or more filtration modules provided with a plurality of hollow-fiber membranes arranged in parallel in one direction and a pair of holding members configured to fix both ends of the plurality of hollow-fiber membranes, and one or more cleaning modules configured to supply bubbles from below the filtration modules, and further includes a mechanism for controlling the operation of the filtration modules so as to perform the operation step and the cleaning step of the operation method.

In the filtration apparatus, since the operation of the filtration modules can be controlled so as to perform the operation step and the cleaning step of the operation method, it is possible to suppress an increase in operation costs while preventing membrane fouling.

### Detailed Description of Embodiments of the Present Invention

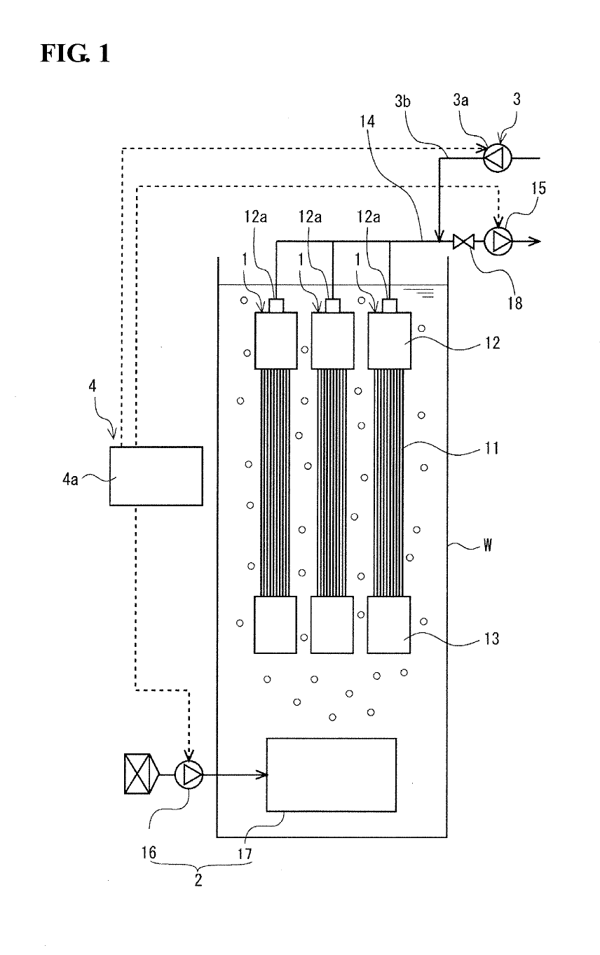

A method of operating a filtration apparatus according to an embodiment of the present invention will be described below with reference to the drawing. The method of operating a filtration apparatus is performed by using a filtration apparatus shown in FIG. 1. First, description will be made regarding a filtration apparatus according to an embodiment of the present invention which is used in the method of operating a filtration apparatus.

<Filtration Apparatus>

The filtration apparatus shown in FIG. 1 carries out a filtration treatment by preventing permeation of the hollow-fiber membranes 11 by impurities contained in a liquid to be treated at the surfaces of the hollow-fiber membranes 11, which will be described later, and allowing permeation of the hollow-fiber membranes 11 by liquid other than the impurities. The filtration apparatus includes a plurality of filtration modules 1, a cleaning module 2 configured to supply bubbles from below the plurality of filtration modules 1, and a cleaning chemical liquid supply mechanism 3 configured to supply a cleaning chemical liquid to the raw water side of the liquid to be treated. The filtration apparatus is used by immersing the plurality of filtration modules 1 and the cleaning module 2 in a storage tank W storing the liquid to be treated. The filtration apparatus also includes a control mechanism 4 for controlling the operation of the plurality of filtration modules 1.

(Filtration Module)

The filtration module 1 includes a plurality of hollow-fiber membranes 11 arranged in parallel in one direction (in the upward-downward direction in this embodiment) and a pair of holding members (an upper holding member 12 and a lower holding member 13) configured to fix both ends of the plurality of hollow-fiber membranes 11.

(Hollow-Fiber Membrane)

The hollow-fiber membrane 11 is obtained by forming, into a tubular shape, a porous membrane which allows water to permeate therethrough and blocks permeation by impurities contained in a liquid to be treated.

As the hollow-fiber membrane 11, a material containing a thermoplastic resin as a main component can be used. Examples of the thermoplastic resin include polyethylene, polypropylene, polyvinylidene fluoride, ethylene-vinyl alcohol copolymers, polyamide, polyimide, polyetherimide, polystyrene, polysulfone, polyvinyl alcohol, polyphenylene ether, polyphenylene sulfide, acetylcellulose, polyacrylonitrile, and polytetrafluoroethylene (PTFE). Among these, preferable is PTFE which is excellent in terms of mechanical strength, chemical resistance, heat resistance, weather resistance, flame resistance, and the like and which is porous, and more preferable is uniaxially or biaxially expanded PTFE. Other polymers and additives such as a lubricant may be appropriately mixed into the material for forming the hollow-fiber membrane 11.

A plurality of hollow-fiber membranes 11 are arranged in a rectangular region which extends in a direction perpendicular to the direction in which the hollow-fiber membranes 11 are arranged in parallel. Furthermore, in the filtration apparatus, a plurality of filtration modules 1 are arranged in parallel at certain intervals in the short-side direction of the region in which the hollow-fiber membranes 11 are arranged.

(Upper Holding Member)

The upper holding member 12 forms an internal space which communicates with hollow portions of the hollow-fiber membranes 11 held therein and is provided with a drain nozzle 12a which discharges the liquid filtrated by the hollow-fiber membranes 11 from the internal space. Furthermore, the drain nozzle 12a is connected to a water collecting pipe 14 which collects the filtrated liquid obtained by filtration of the liquid to be treated. Furthermore, a plurality of water collecting pipes 14 connected to a plurality of filtration modules 1 are merged together and connected to a suction pump 15. The water collecting pipes 14 and the suction pump 15 constitute a drain mechanism of the filtration apparatus. The filtration apparatus is designed as an external pressure-type filtration apparatus in which the internal pressure of the hollow-fiber membranes 11 is made negative by operating the suction pump 15, thereby carrying out a filtration treatment, and the filtration treatment is stopped by stopping the suction pump 15.

(Lower Holding Member)

The lower holding member 13 holds the lower ends of the hollow-fiber membranes 11. The lower holding member 13 may form an internal space as in the upper holding member 12, or may hold the lower ends of the hollow-fiber membranes 11 in such a manner that the openings of the hollow-fiber membranes 11 are blocked.

Furthermore, in order to facilitate handling (transport, installation, replacement, etc.) of the filtration module 1, the upper holding member 12 and the lower holding member 13 may be joined with each other by a joining member. As the joining member, for example, a supporting bar made of metal, a casing (external cylinder) made of resin, or the like may be used.

(Cleaning Module)

The cleaning module 2 is arranged below a plurality of filtration modules 1. The cleaning module 2 supplies bubbles from below the filtration modules 1.

The cleaning module 2 is not particularly limited as long as it can supply bubbles. For example, as shown in FIG. 1, the cleaning module 2 includes an air supplier 16 which supplies air and an air header 17 arranged below the filtration modules 1. As the air supplier 16, for example, a blower, compressor, or the like may be used. Furthermore, as the air header 17, for example, a porous plate or porous tube obtained by forming many pores in a plate or tube made of resin or ceramic may be used.

(Cleaning Chemical Liquid Supply Mechanism)

The cleaning chemical liquid supply mechanism 3 includes a chemical liquid supply pump 3a and a chemical liquid supply pipe 3b which is connected to the chemical liquid supply pump 3a and the water collecting pipe 14 and which can supply a cleaning chemical liquid through the water collecting pipe 14 to the inner side of the hollow-fiber membranes 11 in the cleaning step. Furthermore, the water collecting pipe 14 is provided with an opening and closing valve 18 between a connecting point with the chemical liquid supply pipe 3b and a connecting point with the suction pump 15. In the filtration apparatus, with the opening and closing valve 18 being closed, the cleaning chemical liquid is supplied by the chemical liquid supply pump 3a.

(Control Mechanism)

The control mechanism 4 includes a control unit 4a, such as a personal computer or programmable logic controller. The control mechanism 4 controls the filtration treatment period by a plurality of filtration modules 1 and the stop period after the filtration treatment. Furthermore, the control mechanism 4 controls the cleaning treatment by the cleaning module 2 and the cleaning chemical liquid supply treatment by the cleaning chemical liquid supply mechanism 3 during the stop period.

<Method of Operating Filtration Apparatus>

Next, description will be made regarding a method of operating the filtration apparatus. The method of operating the filtration apparatus includes an operation step and a cleaning step. The method of operating the filtration apparatus may include a step other than the cleaning step between the operation step and the cleaning step. However, it is preferable to perform the operation step and cleaning step alternately and repeatedly. In the method of operating the filtration apparatus, by repeatedly performing the operation step and the cleaning step, it is possible to promote the effect of preventing membrane fouling and the effect of suppressing operation costs for the filtration apparatus.

(Operation Step)

In the operation step, a filtration treatment is carried out with a plurality of filtration modules 1. The operation step is performed under the control of the control mechanism 4. Specifically, in the operation step, the filtration treatment is started when the suction pump 15 is started under the control of the control mechanism 4, and the filtration treatment is stopped when the suction pump 15 is stopped by the control mechanism 4.

In the operation step, the filtration treatment with the filtration modules 1 may be continuously performed. However, it is preferable to repeatedly perform the filtration treatment and cleaning with the cleaning module 2. In the case where the filtration treatment and cleaning are repeatedly performed, the lower limit of the filtration treatment time for one operation is preferably 5 minutes and more preferably 8 minutes. On the other hand, the upper limit of the filtration treatment time is preferably 20 minutes, more preferably 15 minutes, and still more preferably 10 minutes. Furthermore, in the case where the filtration treatment and cleaning are repeatedly performed, the lower limit of the cleaning time for one operation is preferably 0.5 minutes, and more preferably 0.75 minutes. On the other hand, the upper limit of the cleaning time for one operation is preferably 3 minutes, more preferably 2 minutes, and still more preferably 1.5 minutes. In the method of operating the filtration apparatus, in such a manner, by repeatedly performing the filtration treatment with the filtration modules 1 and cleaning with the cleaning module 2 in the operation step, it is possible to easily and reliably perform a stable operation for a long period of time while enhancing the effect of preventing membrane fouling, in combination with the cleaning effect of the cleaning step, which will be described later. Note that, in the cleaning in the operation step, a cleaning chemical liquid may be supplied by the cleaning chemical liquid supply mechanism 3. However, in the method of operating the filtration apparatus, since sufficient cleaning can be performed in the cleaning step, which will be described later, it is rather preferable not to supply the cleaning chemical liquid in the operation step.

The lower limit of the operation time in the operation step is preferably 12 hours, more preferably 18 hours, and still more preferably 23 hours. On the other hand, the upper limit of the operation time in the operation step is preferably 72 hours, more preferably 48 hours, and still more preferably 24 hours. When the operation time in the operation step is less than the lower limit, there is a concern that filtration treatment efficiency may not be sufficiently improved. Contrarily, when the operation time in the operation step exceeds the upper limit, there is a concern that filtration efficiency may not be sufficiently improved because of an increased amount of impurities adhering to the surfaces of the hollow-fiber membranes 11.

Note that, in the operation step, the operation time of the filtration modules may be controlled on the basis of the filtration throughput within the time range described above.

(Cleaning Step)

In the cleaning step, the filtration modules are cleaned while stopping the filtration treatment with the filtration modules for 0.25 to 3 hours. That is, the cleaning step is performed continuously during the operation stop period of the filtration modules 1. Specifically, the cleaning step is started after the suction pump 15 has been stopped under the control of the control mechanism 4 and performed until the suction pump 15 is restarted by the control mechanism 4.

The lower limit of the operation stop period is preferably 0.3 hours and more preferably 0.5 hours. On the other hand, the upper limit of the operation stop period is preferably 2.5 hours and more preferably 2 hours. When the operation stop period is less than the lower limit, there is a concern that it may not be possible to sufficiently perform cleaning. Contrarily, when the operation stop period exceeds the upper limit, there is a concern that the operation stop period may be unnecessarily elongated.

The lower limit of the interval at which the cleaning step is performed is 12 hours, preferably 18 hours, and more preferably 23 hours. On the other hand, the upper limit of the interval at which the cleaning step is performed is 72 hours, preferably 48 hours, and more preferably 24 hours. When the interval at which the cleaning step is performed is less than the lower limit, there is a concern that filtration treatment efficiency may not be sufficiently improved. Contrarily, when the interval at which the cleaning step is performed exceeds the upper limit, there is a concern that it may not be possible to sufficiently prevent membrane fouling, and as a result, it may not be possible to sufficiently suppress operation costs for the filtration apparatus.

Furthermore, in the method of operating the filtration apparatus, it is preferable to perform the cleaning step in the same period. In the method of operating the filtration apparatus, it is possible to repeatedly perform the cleaning step in the same period by allowing the control mechanism 4 to control the operation such that the total time of the operation step and the cleaning step for one operation is 24×n (where n is 1, 2, or 3) hours and repeatedly performing the operation step and the cleaning step. In the method of operating the filtration apparatus, by repeatedly performing the cleaning step in the same period in such a manner, for example, cleaning of a plurality of filtration modules 1 can be performed in a concentrated manner at night when the filtration throughput may be relatively low. As a result, in the method of operating the filtration apparatus, it is possible to maintain a filtration throughput during the day.

In the cleaning step, preferably, bubbles are supplied by the cleaning module 2. Such supply of bubbles is performed by starting the air supplier 16 by the control mechanism 4. In the method of cleaning the filtration apparatus, by supplying bubbles by the cleaning module 2 in the cleaning step, it is possible to appropriately remove impurities which have adhered to the surfaces of the hollow-fiber membranes 11 and to promote the effect of preventing membrane fouling.

In the case where bubbles are supplied by the cleaning module 2 in the cleaning step, preferably, the supply of bubbles are continuously performed during the cleaning step. Furthermore, the supply of bubbles may be performed simultaneously with supply of the cleaning chemical liquid.

The lower limit of the bubble supply period is preferably 0.25 hours, more preferably 0.3 hours, and still more preferably 0.5 hours. On the other hand, the upper limit of the bubble supply period is preferably 3 hours, more preferably 2.5 hours, and still more preferably 2 hours. When the bubble supply period is less than the lower limit, there is a concern that it may not be possible to perform cleaning sufficiently. Contrarily, when the bubble supply period exceeds the upper limit, there is a concern that the cleaning effect may not much increase and the cost required for supplying bubbles may increase.

In the cleaning step, a cleaning chemical liquid may be supplied to the inner side of the hollow-fiber membranes 11 of a plurality of filtration modules 1. Such supply of the cleaning chemical liquid is performed by starting the chemical liquid supply pump 3a by the control mechanism 4. In the method of cleaning the filtration apparatus, by supplying the cleaning chemical liquid to the inner side of the hollow-fiber membranes 11 of the filtration modules 1, it is possible to enhance cleaning power for each operation of the cleaning step, and the effect of preventing membrane fouling can be promoted. In the method of operating the filtration apparatus, even if the cleaning chemical liquid is not supplied in the cleaning step, for example, by continuously supplying bubbles during the operation stop period, it is possible to obtain a sufficient cleaning effect. Accordingly, in the cleaning step, it is not necessarily required to supply the cleaning chemical liquid.

Examples of components contained in the cleaning chemical liquid include sodium hypochlorite, sodium hydroxide, chlorine dioxide, hydrogen peroxide water, and ozone which have a high cleaning effect to organic substances, and oxalic acid, citric acid, nitric acid, hydrochloric acid, sulfuric acid, and the like which have a high cleaning effect to metal oxides.

The timing of supplying the cleaning chemical liquid is not particularly limited, and, for example, may be set to be immediately after the start of the cleaning step. By supplying the cleaning chemical liquid immediately after the start of the cleaning step in such a manner, impurities which have adhered to the surfaces of the hollow-fiber membranes 11 can be appropriately removed easily.

Furthermore, even in the case where the cleaning chemical liquid is supplied in the cleaning step, it is not necessarily required to supply the cleaning chemical liquid in each cleaning step. In the method of cleaning the filtration apparatus, for example, in the case where the operation step and the cleaning step are repeatedly performed, the timing of supplying the cleaning chemical liquid may be determined on the basis of the number of repeated cleaning steps or may be determined on the basis of the total filtration throughput. In the case where the cleaning chemical liquid is supplied each time when the cleaning steps are repeated certain number of times, the number of repeated cleaning steps may be set to be, for example, two to four.

Note that, in the cleaning step, the cleaning period may be controlled on the basis of the filtration throughput in the operation step within the time range described above.

<Advantages>

The method of operating the filtration apparatus includes a cleaning step of cleaning the filtration modules 1 while stopping the filtration treatment with the filtration modules 1 for the period described above. The cleaning step is performed at the intervals described above. Thereby, it is possible to prevent impurities, which have been deposited on the surfaces of the hollow-fiber membranes 11, from blocking the spaces between the hollow-fiber membranes 11, compared with the existing case where, for example, a cleaning cycle is repeated, in which filtration treatment operations, each lasting for about 7 minutes, are intermittently performed with an operation stop period of about one minute interposed therebetween. Therefore, in the method of operating the filtration apparatus, it is possible to suppress an increase in operation costs by promoting a decrease in the chemical liquid cleaning frequency and a reduction in the amount of air during the operation while preventing membrane fouling.

In the method of operating the filtration apparatus, for example, by continuously supplying bubbles during the cleaning step, impurities adhering to the surfaces of the hollow-fiber membranes 11 can be easily removed. Accordingly, in the method of operating the filtration apparatus, even if the amount of the cleaning chemical used is decreased compared with the existing operation method, a sufficient cleaning effect can be obtained.

In the filtration apparatus, since it is possible to control the operation of the filtration modules 1 so as to perform the operation step and the cleaning step, as described above, it is possible to suppress an increase in operation costs while preventing membrane fouling.

### Other Embodiments

It should be considered that the embodiments disclosed this time are illustrative and non-restrictive in all aspects. The scope of the present invention is not limited to the embodiments described above but is defined by the appended claims, and is intended to include all modifications within the meaning and scope equivalent to those of the claims.

For example, the filtration apparatus does not necessarily need to include a plurality of filtration modules, and may include one filtration module. Furthermore, even in the case where the filtration apparatus includes a plurality of filtration modules, the plurality of filtration modules may be separately controlled. As the method of separately controlling a plurality of filtration modules, for example, there is a method in which water collecting pipes connected to drain nozzles of upper holding members are individually connected to separate suction pumps, and the suction pumps are separately controlled.

The filtration apparatus does not necessarily need to include one cleaning module, and may include a plurality of cleaning modules. Furthermore, in the case where the filtration apparatus includes a plurality of cleaning modules, the plurality of cleaning modules may be separately controlled. In the method of operating the filtration apparatus, by separately controlling a plurality of filtration modules and separately controlling a plurality of cleaning modules in accordance with the operation of the plurality of filtration modules, the cleaning time can be shifted from one filtration module to another, and a filtration treatment can be performed without a break.

1. A method of operating a filtration apparatus which includes one or more filtration modules provided with a plurality of hollow-fiber membranes arranged in parallel in one direction and a pair of holding members configured to fix both ends of the plurality of hollow-fiber membranes, and one or more cleaning modules configured to supply bubbles from below the filtration modules, the method comprising:
an operation step of carrying out a filtration treatment with the filtration modules; and
a cleaning step of cleaning the filtration modules while stopping the filtration treatment with the filtration modules for 0.25 to 3 hours,
wherein the cleaning step is performed at intervals of 12 to 72 hours.

2. The method of operating a filtration apparatus according to claim 1, wherein the operation step and the cleaning step are repeatedly performed.

3. The method of operating a filtration apparatus according to claim 1, wherein, in the cleaning step, bubbles are supplied by the cleaning modules.

4. A filtration apparatus comprising:
one or more filtration modules provided with a plurality of hollow-fiber membranes arranged in parallel in one direction and a pair of holding members configured to fix both ends of the plurality of hollow-fiber membranes; and
one or more cleaning modules configured to supply bubbles from below the filtration modules,
the filtration apparatus further comprising a mechanism for controlling the operation of the filtration modules so as to perform the operation step and the cleaning step of the operation method according to claim 1.
